(19) United States
(12) Patent Application Publication
(10) Pub. No.: US 2025/0256745 A1
(43) Pub. Date: Aug. 14, 2025

(54) COMPUTER-IMPLEMENTED METHOD AND APPARATUS FOR MODIFYING A RAIL VEHICLE PATH

(71) Applicant: HaCon Ingenieurgesellschaft mbH, Hannover (DE)

(72) Inventors: Munindra Nath Chakravarty, Hannover (DE); Ralf Meier, Hannover (DE)

(21) Appl. No.: 19/052,510

(22) Filed: Feb. 13, 2025

(30) Foreign Application Priority Data
Feb. 13, 2024 (EP) 24157364.1

(51) Int. Cl. B61L 27/16; B61L 27/12

(52) U.S. Cl. CPC B61L 27/16; B61L 27/12

(57) ABSTRACT

A computer-implemented method of modifying a rail vehicle path provided by a graphical timetable application. A graphical timetable is displayed with a first dimension representing time and a second dimension representing a location of the rail vehicle. A first user input selects a rail vehicle path represented by a line graph displayed as part of the graphical timetable. To allow for easy-to-use modification of the rail vehicle path, a second user input selects a stopping element representing a stopping point of the rail vehicle path and a first drag user input drags the stopping element in the first dimension, thereby changing the time of the stopping point, and/or in the second dimension, changing the location of the stopping point. A third user selection selects a starting point of the rail vehicle path and a second drag user input drags the starting element in the time dimension and/or in the location dimension.

### CROSS-REFERENCE TO RELATED APPLICATION

This application claims the priority, under 35 U.S.C. § 119, of European Patent Application EP 24157364.1, filed Feb. 13, 2024; the prior application is herewith incorporated by reference in its entirety.

### FIELD AND BACKGROUND OF THE INVENTION

The invention relates to a computer-implemented method of modifying a rail vehicle path provided by a graphical timetable application. The invention further relates to a method of operating a transportation system with a plurality of vehicles. The invention further relates to an apparatus for providing a modification of a path of a rail vehicle provided by a graphical timetable application. Lastly, the invention relates to a transportation system.

Transportation planning systems, graphical timetables, and user interfaces for transportation planning systems are generally known in the art.

European patent application EP 3 539 844 A1 and its counterpart patent application publication US 2019/0228358 A1 disclose a transportation system for operating trains on a railway line with a plurality of stations. The transportation system comprises a schedule planning system for determining a schedule for the railway line. The transportation system further discloses a schedule proposal system for proposing a change in the schedule for the railway line, wherein the schedule proposal system includes a data server for storing information collected at the plurality of stations and related to passengers, and a computing server storing a program for predicting the numbers of passengers who wait for trains and a program for determining an increase or reduction in the number of trains to be operated. The computing server executes, at predetermined time intervals, the program for predicting the numbers of passengers who wait for trains and the program for determining an increase or reduction in the number of trains to be operated. The program for predicting the numbers of passengers who wait for trains predicts, based on the information stored in the data server and related to passengers, the numbers of passengers who wait for trains at the plurality of stations in a predetermined time zone. The program for determining an increase or reduction in the number of trains to be operated determines, based on the numbers of passengers who wait for trains at the plurality of stations in the predetermined time zone, whether or not the number of trains to be operated is to be increased or reduced. The schedule planning system updates a schedule for the predetermined time zone to a schedule in which the number of trains to be operated has been increased or reduced based on the determination, made by the schedule proposal system, of whether, or not, the number of trains to be operated is to be increased or reduced.

### SUMMARY OF THE INVENTION

It is an object of the invention to provide an easy-to-use method of modifying a rail vehicle path provided by a graphical timetable application.

With the above and other objects in view there is provided, in accordance with the invention, a computer-implemented method of modifying a rail vehicle path provided by a graphical timetable application. The method comprises the following steps:
displaying the graphical timetable by a display, the graphical timetable including:
   a first dimension representing time, and
   a second dimension representing a location of the rail vehicle;
receiving via a user interface a first selection user input corresponding to a selection of a rail vehicle path represented by a line graph displayed as part of the graphical timetable;
receiving via the user interface:
   a second selection user input corresponding to a selection of a stopping element representing a stopping point of the rail vehicle path; and
   a first drag user input corresponding to a drag of the stopping element in at least one of the first dimension, thereby changing a time of the stopping point, or the second dimension, thereby changing the location of the stopping point;
   and/or
   a third selection user input corresponding to a selection of a starting element representing a starting point of the rail vehicle path; and
   a second drag user input corresponding to a drag of the starting element in at least one of the first dimension, thereby changing the time of the starting point, or the second dimension, thereby changing the location of the starting point.

In other words, one aspect of the invention relates to a computer-implemented method of modifying a rail vehicle path provided by a graphical timetable application. The method comprises displaying the graphical timetable by way of a display. The graphical timetable includes a first dimension representing time and a second dimension representing a location of the rail vehicle. The method comprises receiving via a user interface a first selection user input corresponding to a selection of a rail vehicle path represented by a line graph displayed as part of the graphical timetable. Moreover, the method may comprise receiving via the user interface a second selection user input corresponding to a selection of a stopping element representing a stopping point of the rail vehicle path. Furthermore, the method may comprise receiving a first drag user input corresponding to a drag of the stopping element in the first dimension, thereby changing the time of the stopping point, and/or in the second dimension, thereby changing the location of the stopping point. Moreover, the method may further or alternatively comprise receiving via the user interface a third selection user input corresponding to a selection of a starting element representing a starting point of the rail vehicle path. Furthermore, the method comprises receiving a second drag user input corresponding to a drag of the starting element in the first dimension, thereby changing the time of the starting point, and/or in the second dimension, thereby changing the location of the starting point.

The invention is based on the finding that the change of the rail vehicle path by means of existing graphical timetable applications is complex and time-consuming since numerical values representing stopping points and starting points have to be amended manually.

The solution according to the present invention provides for an easy-to-use and intuitive way of modifying the rail vehicle path as part of the graphical timetable.

The term “graphical timetable” is understood by those of skill in the pertinent art as a visual representation of the scheduled movements of rail vehicles on a railway network. It is a tool for railway operators, dispatchers, and train drivers to plan, monitor, and control rail vehicle movements.

The rail vehicle, for example, may be a multiple unit train. In the alternative, the rail vehicle may consist of a locomotive and several cars.

The first dimension is preferably represented by a so-called X-Axis as part of the graphical timetable. The second dimension is preferably represented by a number of stations, or stops, on a so-called Y-Axis. The stations may be stations located along the path of the rail vehicle.

The rail vehicle path is the path along which the rail vehicle may travel during operation. The rail vehicle path is represented by a line graph displayed as part of the graphical timetable.

The term “user interface” may be understood to comprise the visual and interactive elements of the graphical timetable application that enable users to interact with the transportation system, preferably to interact with the rail vehicle path. The visual and interactive elements may be displayed by the display displaying the graphical timetable application. The interaction may be performed by means of one or more user interface devices, such as a touch-sensitive surface, a keyboard, a mouse and/or a joystick, etc.

The graphical timetable application may be understood as a computer program that is executed by a processor of a computer. This computer program provides the graphical timetable for display and interaction with the user. It further provides the rail vehicle path as well as the modified rail vehicle path to be implemented in operation.

The stopping element preferably represents a stopping point of the rail vehicle along the rail vehicle path. The stopping element may be displayed as a point-like item on the line graph representing the rail vehicle path. The stopping point is a point at a certain location and a certain time at which the vehicle stops, e.g., at a station along the rail vehicle path.

The starting element preferably represents a starting point of the rail vehicle along the rail vehicle path. The starting element may be displayed as a point-like item on the line graph representing the rail vehicle path. The starting point is a point at a certain location and a certain time at which the vehicle starts, e.g., at a station along the rail vehicle path.

In other words, the stopping element and starting element, respectively, is a visualized item displayed as part of the graphical timetable. The terms “stopping point” and “starting point,” respectively, preferably refer to the actual points in space and time of the real-world rail vehicle in operation as part of a transportation system.

The selection of the rail vehicle path is preferably based on an interaction of the user with the user interface. The user preferably selects one rail vehicle path out of a plurality of rail vehicles paths.

The selection of the stopping element and/or starting element is preferably based on an interaction of the user with the user interface. The user preferably selects the stopping element and/or starting element out of a plurality of stopping elements and/or starting elements of one line graph representing the rail vehicle path.

The drag of the stopping element and/or starting element is preferably based on an action of the user who is clicking, holding, and dragging the stopping element by means of the user interface, for example by using the mouse of the user interface.

The terms “first,” “second,” “third,” etc. are used herein to distinguish between the different user inputs. They do not prescribe an order or sequence of events in any way, e.g., such that first user interaction takes place before the second user interaction.

The graphical timetable application is preferably fed with real-time data representing the current location of the rail vehicle at the current time. Moreover, the graphical timetable application outputs the modified rail vehicle path to a physical transportation system. The output is preferably used for operation of the transportation system.

According to a preferred embodiment, the computer-implemented method according to the present invention comprises receiving a fourth selection user input corresponding to a selection of a displayed item via the user interface and initiating the modification of the rail vehicle path in response to receiving the fourth selection user input.

The selection of the displayed item is preferably based on an action of the user clicking on an item displayed by way of the display. Such an item may be a visualized button for initiation and activation of the modification of the rail vehicle path.

According to a further preferred embodiment, the computer implemented method according to the present invention comprises updating a value of a data representation, the data representation indicating the location and time of the stopping point and/or starting point in response to modifying the rail vehicle path by changing the location and time of the stopping point and/or starting point while the first and/or second drag user input is received by the graphical timetable application.

This allows for a simultaneous change of numeric data related to the rail vehicle path. Moreover, also the stopping point and starting point of the rail vehicle (in the real world) is adapted accordingly.

The data representation is preferably realized by a visualized panel displaying information relating to the rail vehicle path. Such information preferably includes the location and time of the stopping point and/or starting point. The visualized panel may be displayed together with and in addition to the graphical timetable.

According to a further preferred embodiment, the computer-implemented method according to the present invention comprises displaying a preliminary modified rail vehicle path in addition to the rail vehicle path displayed as part of the graphical timetable, the preliminary modified rail vehicle path presenting the current drag received by the graphical timetable application via the user interface.

Thereby, the user obtains a direct response of how the drag would change the rail vehicle path if entered.

The preliminary modified rail vehicle path is preferably understood by the skilled person as a preview rail vehicle path.

Preferably, the preliminary modified rail vehicle path is displayed while the user drags the stopping element and/or the starting element. Preferably, the preliminary modified rail vehicle path is displayed in direct response to the receiving of the drag user input, in particular simultaneously to the dragging of the stopping element and/or starting element.

According to a further preferred embodiment of the computer-implemented method according to the present invention, a pair element consists of the stopping element and starting element at one location of the rail vehicle path. The method further comprises receiving, by the graphical timetable application via the user interface, a fifth selection user input corresponding to a selection of the pair element and receiving a third drag user input corresponding to a drag of the pair element in the second dimension, thereby changing the location of the pair element.

This embodiment provides for an intuitive and suitable way of modifying the rail vehicle path. It is intuitive to modify a stopping element together with the respective starting element of the rail vehicle at a certain station. It is also suitable for the user to handle the stopping element and starting element as a pair together. Moreover, when changing the location of the stopping point of the rail vehicle, it is necessary to change the respective starting point of the rail vehicle at the same location (since the rail vehicle may not start at a different location than the location at which it stopped).

According to a further preferred embodiment of the computer-implemented method according to the present invention, a pair element consists of the stopping element and starting element at one location of the rail vehicle path. The method further comprises receiving by the graphical timetable application via the user interface a sixth selection user input corresponding to a selection of the stopping element and a fourth drag user input corresponding to a drag of the stopping element in the first dimension, thereby changing the time of the stopping point. The method alternatively comprises receiving by the graphical timetable application via the user interface a seventh selection user input corresponding to a selection of the starting element and a fifth drag user input corresponding to a drag of the starting element in the first dimension, thereby changing the time of the starting element.

This embodiment allows for individually changing the time of the respective stopping point and/or starting point of the pair element.

According to a further preferred embodiment of the computer-implemented method according to the present invention, the rail vehicle path comprises a plurality of stopping points represented by stopping elements and a plurality of starting points represented by starting elements. The method further comprises receiving by the graphical timetable application via the user interface an eighth selection user input corresponding to a selection of a subset of the plurality of stopping elements and starting elements, the selection comprising drawing a selection area over the subset. The method further comprises modifying the rail vehicle path based on receiving a sixth drag user input corresponding to a drag of the subset in the first dimension, thereby changing the time of the subset, and/or in the second dimension, thereby changing the location of the subset.

For example, if the subset is drawn into the second dimension, all stopping points and starting points of this subset will move to a respective different station along the rail vehicle path. In particular, if the subset is drawn into the direction of movement of the rail vehicle, all stopping points and starting points of this subset will move to the next station along the rail vehicle path.

According to a further preferred embodiment, the rail vehicle path comprises a plurality of stopping points represented by stopping elements and a plurality of starting points represented by starting elements. The computer-implemented method further comprises receiving a selection of a further displayed item via the user interface, thereby selecting all stopping elements and starting elements of the rail vehicle path. The method further comprises modifying the rail vehicle path based on receiving a drag of all selected stopping elements and starting elements. If all selected stopping elements and starting elements are dragged in the first dimension, the time of all stopping points and starting points of the rail vehicle path is changed. If all selected stopping elements and starting elements are dragged in the second dimension, the location of all stopping points and starting points of the rail vehicle path is changed.

The selection of the further displayed item is preferably based on an action of the user clicking on an item displayed by means of the display. Such an item may be a visualized “select all button” for selecting all stopping elements and all starting elements of the rail vehicle path.

With the above and other objects in view there is also provided, in accordance with the invention, a data processing apparatus comprising means for carrying out the method of any of the methods described herein. The apparatus can be, e.g., a generic computer, a special-purpose system such as a display system for use in a central traffic control, such as an interlocking.

The invention also relates to a computer program comprising instructions which, when the program is executed by a computer, cause the computer to carry out any of the methods disclosed herein.

Moreover, the invention relates to a non-transitory computer-readable medium comprising instructions which, when executed by a computer, cause the computer to carry out any of the method variations disclosed herein.

The computer-readable medium is, for example, part of a storage unit that stores and/or provides the computer program. Alternatively and/or additionally, the computer-readable medium is, for example, part of a network service, a computer system, a server system, in particular a distributed, e.g., cloud-based computer system and/or virtual computing system, which preferably stores and/or provides the computer program product in the form of a data stream. This provision is carried out in the form of a program data block as a file, in particular as a download file, or as a data stream, in particular as a download data stream, of the computer program. The provision can also be carried out, for example, as a partial download consisting of several parts. Such a computer program is, for example, read into a system using the computer-readable medium, so that the inventive method is executed on a computer.

The invention further relates to a method of operating a transportation system comprising a plurality of rail vehicles. The method comprises operating at least one of the plurality of rail vehicles in accordance with a rail vehicle path provided by any of the methods disclosed herein.

Preferably, the method comprises operating at least one of the plurality of railway vehicles in accordance with a rail vehicle path and operating the at least one rail vehicle in accordance with a modified rail vehicle path in response to a modification of the rail vehicle path according to any of the methods disclosed herein.

The transportation system is preferably part of the rail infrastructure.

The invention further relates to an apparatus for providing a modification of a rail vehicle path provided by a graphical timetable application. The apparatus may comprise a display configured to display a graphical timetable, wherein the graphical timetable includes a first dimension representing time and a second dimension representing a location of the rail vehicle. The apparatus may comprise a user interface configured to receive a first selection user input corresponding to a selection of a rail vehicle path represented by a line graph displayed as part of the graphical timetable. The graphical timetable application may be configured to receive via the user interface a second selection user input corresponding to a selection of a stopping element representing a stopping point of the rail vehicle path and a first drag user input corresponding to a drag of the stopping element in the first dimension, thereby changing the time of the stopping point, and/or in the second dimension, thereby changing the location of the stopping point. Moreover or as an alternative, the graphical timetable application may be configured to receive via the user interface a third selection user input corresponding to a selection of a starting element representing a starting point of the rail vehicle path and a second drag user input corresponding to a drag of the starting element in the first dimension, thereby changing the time of the starting point, and/or in the second dimension, thereby changing the location of the starting point.

The invention further relates to a transportation system. The transportation system comprises a plurality of vehicles and any of the apparatuses disclosed herein. The apparatus may be configured to modify an operation of at least one of the plurality of rail vehicles based on a modified rail vehicle path provided by means of the apparatus.

The transportation system may be part of a rail infrastructure.

Accordingly, the invention may further relate to a rail infrastructure comprising a transportation system disclosed herein.

For advantages, embodiments, and design details of the data processing apparatus, computer program, computer-readable medium, method of operating a transportation system, apparatus for providing a modification of a rail vehicle path, and transportation system according to the present invention, reference may be made to the foregoing description of the corresponding features of the computer-implemented method of modifying the rail vehicle path provided by a graphical timetable application according to the present invention.

Regardless of the grammatical gender of a given term, people of male, female, or other gender identities are included.

Other features which are considered as characteristic for the invention are set forth in the appended claims.

Although the invention is illustrated and described herein as embodied in a computer-implemented method for modifying a rail vehicle path, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic flow chart representing the method steps of a first embodiment of a computer-implemented method according to the present invention;

FIG. 2 is a schematic illustration of an embodiment of an apparatus according to the present invention;

FIG. 3 shows a display of the apparatus showing a graphical timetable;

FIG. 4 shows the display showing a selected rail vehicle path;

FIG. 5 shows the display showing a drag of a stopping element;

FIG. 6 shows the display showing a drag of a starting element;

FIG. 7 shows a schematic flow chart representing the method steps of a second embodiment of the computer-implemented method according to the present invention;

FIG. 8 shows the display showing a drag of a pair element;

FIG. 9 shows a schematic flow chart representing the method steps of a third embodiment of the computer-implemented method according to the present invention; and

FIG. 10 shows the display showing a drag of a subset.

### DETAILED DESCRIPTION OF THE INVENTION

FIG. 1 depicts a schematic flow chart representing the steps of the first embodiment of the computer-implemented method according to the present invention.

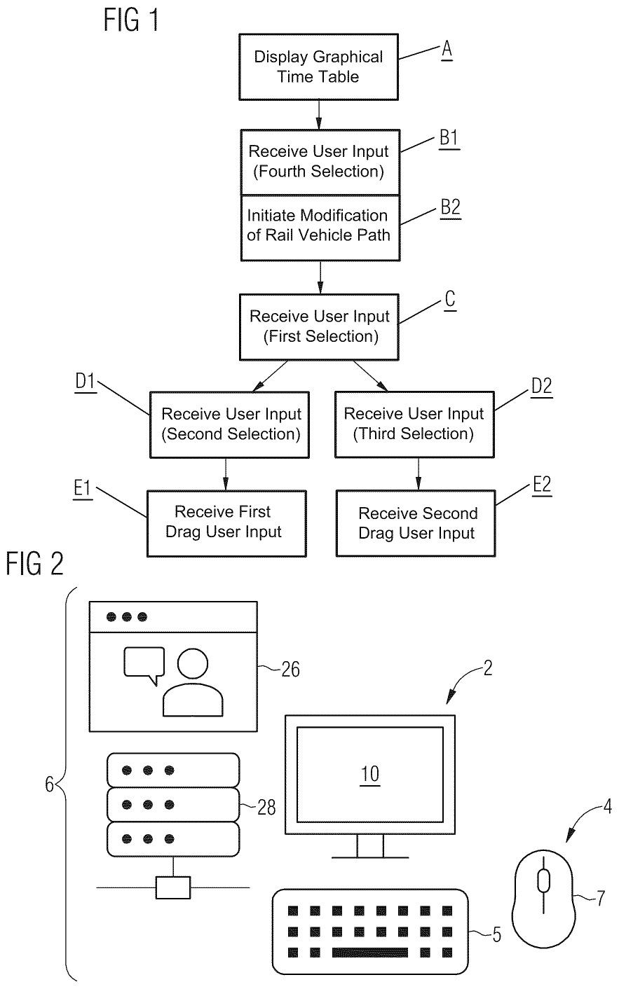

FIG. 2 schematically depicts the setup of an embodiment of an apparatus 2 according to the present invention. The apparatus 2 has a display 10 and a user interface 4 including a keyboard 5 and a mouse 7. The display 10, the keyboard 5 and mouse 7 are part of a desktop computer arrangement 6.

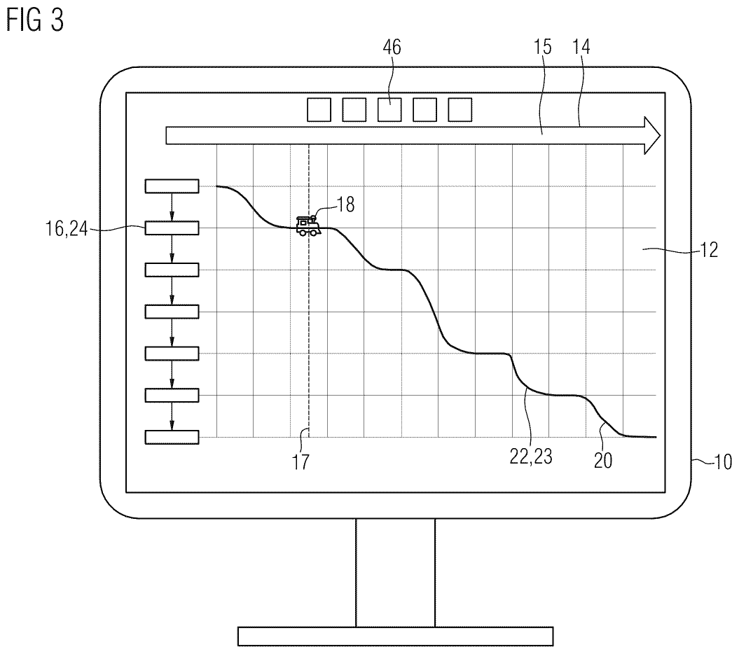

FIG. 3 depicts a view onto the display 10 depicted in FIG. 2 displaying a graphical timetable 12. The graphical timetable 12 is represented by a diagram. The graphical timetable 12 includes a first dimension representing time 14. The graphical timetable 12 includes a second dimension representing a location 16 of a rail vehicle 18. The time 14 is represented by an axis 15 of the diagram. The current time is represented by dotted vertical line 17 moving from left to right as time elapses.

A rail vehicle path 20 is represented by dashed line 22 being a line graph 23. The current location 16 of the rail vehicle 18 represents a respective station 24 at which the rail vehicle 18 may stop and start along the rail vehicle path 20.

In an actual implementation of a graphical timetable according to the present invention, a plurality of rail vehicle paths would be shown as part of the graphical timetable. FIGS. 3-5, 6, and 8 show only one rail vehicle path each for the sake of simplicity and understanding of the gist of the present invention.

The configuration depicted in FIG. 3 is an example of the configuration that is displayed in a method step A (depicted in FIG. 1) according to which the graphical timetable 12 is displayed by means of a display 10.

In a further method step B1, a fourth selection user input corresponding to a selection of an item 46 (depicted in FIG. 3) displayed by the display 10 is received by a graphical timetable application 26 via the user interface 4. The graphical timetable application 26 is executed by a computer 28 of the apparatus 2. The computer 28 comprises a processor as well as a storage medium for storing the graphical timetable application 26. The graphical timetable application 26 receives an information, data, a command, etc., representing the selection of the displayed item 46. In response to receiving this fourth selection user input, the modification of the rail vehicle path 20 is initiated in a method step B2.

In a further method step C, a first selection user input corresponding to a selection of the rail vehicle path 20 is received by the graphical timetable application 26 via the user interface 4 of the apparatus 2. In particular, the graphical timetable application 26 executed by the computer 28 receives an information, data, a command, etc., representing the selection of the rail vehicle path 20. This selection may be a selection of a rail vehicle path out of a plurality of rail vehicle paths displayed as part of the graphical timetable 12 (not shown in FIG. 3). The selection is performed by a user via the user interface 4.

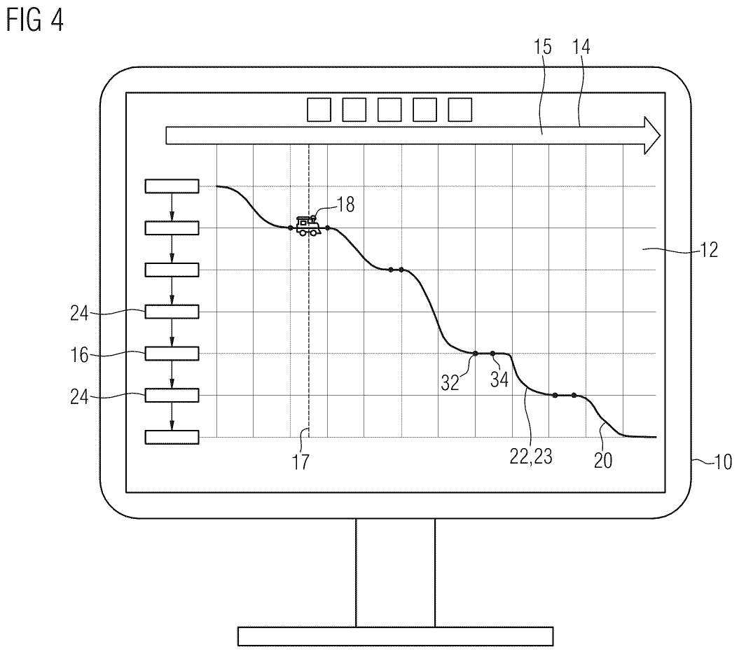

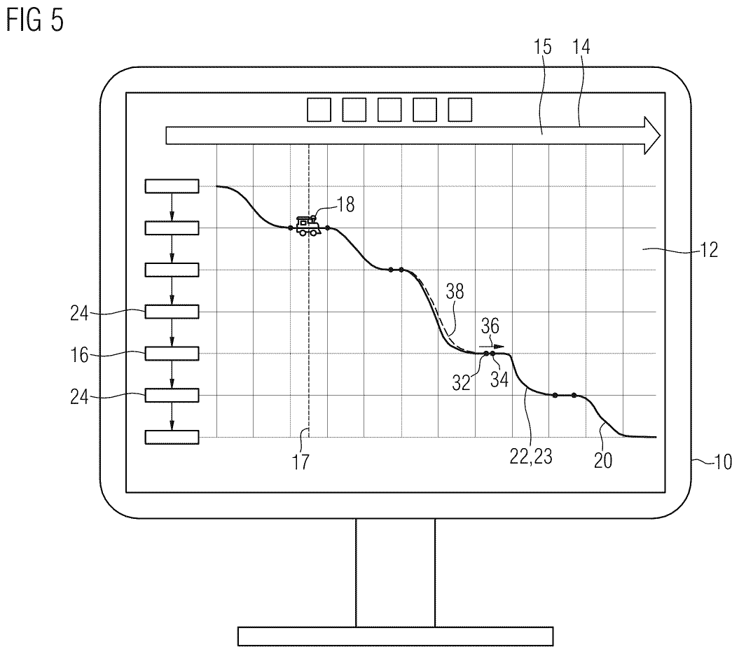

The selected rail vehicle path 20 is depicted with stopping elements 32 and starting elements 34 in FIG. 4 which may also be referred to as control dots. Each stopping element 32 represents a stopping point of the rail vehicle path 20 at which the rail vehicle 18 stops at a respective station 24. Each starting element 34 represents a starting point of the rail vehicle path 20 at which the rail vehicle starts driving at a respective station 24.

In a further method step D1, a second selection user input corresponding to a selection of one of the stopping elements is received via the user interface 4. For example, the stopping element 32 is selected by the user via the user interface 4 by clicking on it.

In a further method step E1, a first drag user input corresponding to a drag of the stopping element 32 in the first dimension is received by the graphical timetable application 26 via the user interface 4. The drag user input may be based on an action of the user who is clicking, holding, and drawing the stopping element 32 by means of the user interface 4, for example by use of the mouse 7. The drag is depicted as a drag 36 in the first dimension in FIG. 5. The drag leads to change of the stopping point (represented by the stopping element 32) to a later point in time. In addition to the drag 36, a preliminary modified rail vehicle path 38 is depicted as part of the graphical timetable 12 as a dotted line. This preliminary modified rail vehicle path 38 is displayed in addition to the rail vehicle path 20. The preliminary modified rail vehicle path 38 shows how the drag 36 influences the rail vehicle path 20 if the modified stopping point is realized in the actual operation of the rail vehicle 12.

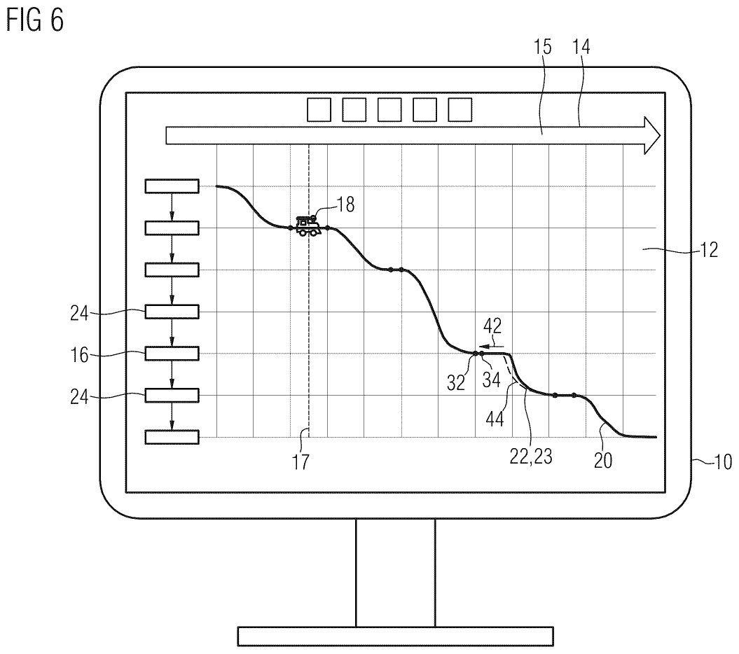

As an alternative or in addition to the dragging of the stopping element 32, in a method step D2, a third selection user input corresponding to a selection of one of the starting elements 34 is received via the user interface 4. In a method step E2, a second drag user input corresponding to a drag of the starting element 34 in the first dimension is received by the graphical timetable application 26 via the user interface 4. The drag user input may be based on an action of the user who is clicking, holding, and drawing the starting element 34 by means of the user interface 4, for example by use of the mouse 7. This drag is depicted as a drag 42 in the first dimension in FIG. 6. The drag leads to a change of the starting point (represented by the starting element 34) to an earlier point in time. In addition to the drag 42, a preliminary modified rail vehicle path 44 is depicted as part of the rail vehicle path 20 as a dotted line. This preliminary modified rail vehicle path 44 is displayed in addition to the rail vehicle path 20.

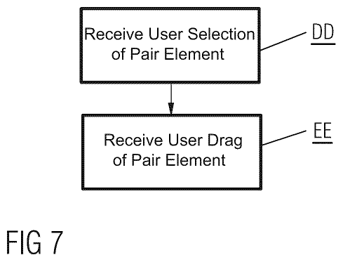

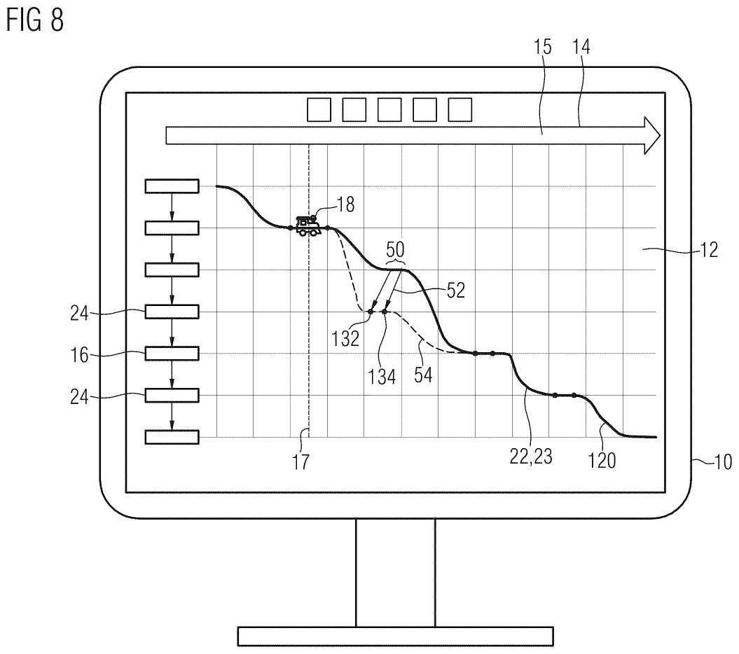

In the second embodiment of the method according to the present invention, a pair element 50 depicted in FIG. 8 consists of a stopping element 132 and starting element 134 at one location of the rail vehicle path 120. In a method step DD depicted in FIG. 7, a fifth selection user input corresponding to a selection of the pair element 50 is received by the graphical timetable application 26 via the user interface 4.

In a method step EE depicted in FIG. 7, a third drag user input corresponding to a drag of the pair element 50 in the second dimension is received by the graphical timetable application 26 via the user interface 4. The command may be based on an action of the user who is clicking, holding, and drawing the pair element by means of the user interface 4, for example by use of the mouse 7. The drag is depicted as a drag 52 in the first and second dimension in FIG. 8. In addition to the drag 52, a preliminary modified rail vehicle path 54 is depicted as part of the graphical timetable 12 as a dotted line. This preliminary modified rail vehicle path 54 is displayed in addition to the rail vehicle path 120. The preliminary modified rail vehicle path 54 shows how the drag 52 influences the rail vehicle path 120 if the modified stopping point and starting point relating to the pair element 50 is realized in the actual operation of the rail vehicle 12.

This embodiment is particularly advantageous in case of changing the location of a stop of a rail vehicle to a different station along the rail vehicle path 120. If a stopping point is changed to a different station, the respective starting point needs to be changed to the same station. This is achieved by paring the respective stopping element 132 and starting element 134 to form the pair element 50 that can be modified by the user interacting with the user interface 4.

Moreover, the respective stopping element or starting element of the pair element 50 may be changed individually based on a drag by the user in the first dimension, thereby changing the time of stopping element (fourth drag user input) or starting element (fifth drag user input), respectively.

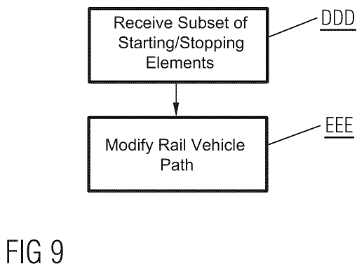

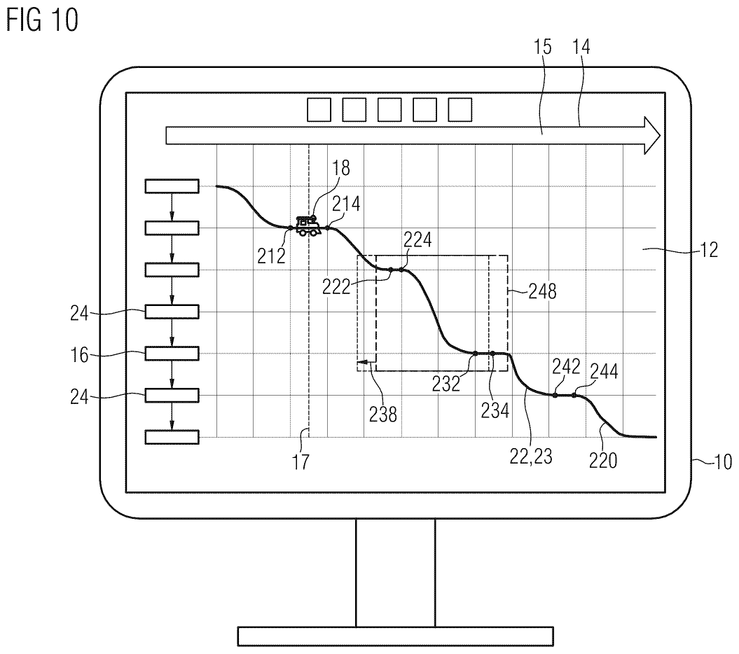

In the third embodiment of the method according to the present invention, the rail vehicle path 220 depicted in FIG. 10 comprises a plurality of stopping points represented by stopping elements 212, 222, 232, 242 and starting points represented by starting elements 214, 224, 234, 244. In a method step DDD depicted in FIG. 9, an eighth selection user input corresponding to a selection of a subset 222, 224, 232, 234 of the plurality of stopping elements and starting elements is received by the graphical timetable application 26 via the user interface 4. The selection may be based on an action of the user drawing a selection area 248 over the subset 222, 224, 232, 234 (by use of the mouse 7). In a further method step EEE depicted in FIG. 9, the rail vehicle path 220 is modified in accordance with a drag of the subset in the first dimension, thereby changing the time of the subset 222, 224, 232, 234, and/or in the second dimension, thereby changing the location of the subset 222, 224, 232, 234. The drag may be based on an action by the user clicking, holding, and drawing the subset by means of the user interface 4. The drag is depicted as a drag 238 in the first dimension in FIG. 10. The drag leads to a change of the time of the subset to an earlier point in time of the respective stopping points and starting points of the subset. A preliminary modified rail vehicle path (not depicted in FIG. 10) may be shown in addition to the rail vehicle path 220 as part of the graphical timetable 12.

In the following claims, the expression “at least one of A or B” should be understood, similar to “and/or,” to include element A only, element B only, or elements A and B.

Although the invention is illustrated and described in detail by the preferred embodiment, the invention is not limited by the disclosed examples, and other variations can be derived from them by those of skill in the pertinent art without departing from the scope of the invention.

1. A computer-implemented method of modifying a rail vehicle path provided by a graphical timetable application, the method comprising the following steps:
displaying the graphical timetable by a display, the graphical timetable including:
a first dimension representing time, and
a second dimension representing a location of the rail vehicle;
receiving via a user interface a first selection user input corresponding to a selection of a rail vehicle path represented by a line graph displayed as part of the graphical timetable;
receiving at least one of the following:
via the user interface:
a second selection user input corresponding to a selection of a stopping element representing a stopping point of the rail vehicle path; and
a first drag user input corresponding to a drag of the stopping element in at least one of the first dimension, thereby changing a time of the stopping point, and/or in the second dimension, thereby changing the location of the stopping point;
and/or
via the user interface:
a third selection user input corresponding to a selection of a starting element representing a starting point of the rail vehicle path; and
a second drag user input corresponding to a drag of the starting element in at least one of the first dimension, thereby changing the time of the starting point, and/or in the second dimension, thereby changing the location of the starting point.

2. The method according to claim 1, which comprises:
receiving a fourth selection user input corresponding to a selection of a displayed item via the user interface and initiating a modification of the rail vehicle path in response to receiving the fourth selection user input.

3. The method according to claim 1, which comprises:
updating a value of a data representation, the data representation indicating the location and the time of at least one of the stopping point or starting point in response to modifying the rail vehicle path by changing the location and the time of at least one of the stopping point or starting point while at least one of the first or second drag user input is received by the graphical timetable application.

4. The method according to claim 1, which comprises:
displaying a preliminary modified rail vehicle path in addition to the rail vehicle path displayed as part of the graphical timetable, the preliminary modified rail vehicle path representing the drag user input received by the graphical timetable application via the user interface.

5. The method according to claim 1, which comprises:
providing a pair element consisting of the stopping element and starting element at one location of the rail vehicle path;
receiving by the graphical timetable application via the user interface a fifth selection user input corresponding to a selection of the pair element; and
receiving by the graphical timetable application via the user interface a third drag user input corresponding to a drag of the pair element in the second dimension, thereby changing the location of the pair element.

6. The method according to claim 1, which comprises:
providing a pair element consisting of the stopping element and starting element at one location of the rail vehicle path;
receiving by the graphical timetable application via the user interface:
a sixth selection user input corresponding to a selection of the stopping element and a fourth drag user input corresponding to a drag of the stopping element in the first dimension, thereby changing the time of the stopping point; or
a seventh selection user input corresponding to a selection of the starting element and a fifth drag user input corresponding to a drag of the starting element the first dimension, thereby changing the time of the starting element.

7. The method according to claim 1, which comprises:
providing the rail vehicle path with a plurality of stopping points represented by stopping elements (212, 222, 232, 242) and a plurality of starting points represented by starting elements (213, 224, 234, 244);
receiving by the graphical timetable application via the user interface an eighth selection user input corresponding to a selection of a subset (222, 224, 232, 234) of the plurality of stopping elements and starting elements, the selection comprising drawing a selection area over the subset (222, 224, 232, 234);
modifying the rail vehicle path based on receiving a sixth drag user input corresponding to a drag of the subset in at least one of the first dimension, thereby changing the time of the subset (222, 224, 232, 234), or in the second dimension, thereby changing the location of the subset (222, 224, 232, 234).

8. The method according to claim 1, which comprises:
providing the rail vehicle path with a plurality of stopping points represented by stopping elements (212, 222, 232, 242) and a plurality of starting points represented by starting elements (213, 224, 234, 244);
receiving a ninth selection user input corresponding to a selection of a further displayed item via the user interface, thereby selecting all stopping elements and starting elements of the rail vehicle path part; and
modifying the rail vehicle path based on receiving a seventh drag user input corresponding to a drag of all selected stopping elements and starting elements.

9. A data processing apparatus, comprising a processor for carrying out the method according to claim 1.

10. A computer program, comprising non-transitory instructions which, when the program is executed by a computer, cause the computer to carry out the method according to claim 1.

11. A non-transitory computer-readable medium comprising instructions which, when executed by a computer, cause the computer to carry out the method according to claim 1.

12. A method of operating a transportation system having a plurality of rail vehicles, the method comprising:
operating at least one of the plurality of rail vehicles in accordance with a rail vehicle path generated by executing the method according to claim 1.

13. An apparatus for providing a modification of a rail vehicle path, the apparatus comprising:
a graphical timetable application for providing the rail vehicle path;
a display configured for displaying a graphical timetable, the graphical timetable having:
a first dimension representing time and
a second dimension representing a location of the rail vehicle;
a user interface configured for receiving a first selection user input corresponding to a selection of a rail vehicle path represented by a line graph displayed as part of the graphical timetable;
said graphical timetable application being configured for at least one of:
receiving via the user interface
a second selection user input corresponding to a selection of a stopping element representing a stopping point of the rail vehicle path, and
a first drag user input corresponding to a drag of the stopping element in at least one of the first dimension, thereby changing the time of the stopping point, and/or in the second dimension, thereby changing the location of the stopping point;
and/or
receiving via the user interface
a third selection user input corresponding to a selection of a starting element representing a starting point of the rail vehicle path, and
a second drag user input corresponding to a drag of the starting element in at least one of the first dimension, thereby changing the time of the starting point, and/or in the second dimension, thereby changing the location of the starting point.

14. A transportation system, comprising:
a plurality of rail vehicles, and
an apparatus according to claim 13.
